(19) United States
(12) Patent Application Publication
(10) Pub. No.: US 2026/0341930 A1
(43) Pub. Date: Oct. 29, 2026

(54) CELL

(71) Applicant: HONDA MOTOR CO., LTD., Tokyo (JP)

(72) Inventors: Yoshihiko Nakajima, Wako-shi (JP); Hideaki Sasaki, Wako-shi (JP)

(21) Appl. No.: 19/549,025

(22) Filed: Feb. 25, 2026

(30) Foreign Application Priority Data
Mar. 12, 2025 (JP) 2025-039004

(51) Int. Cl. H01M 50/595; H01M 50/586

(52) U.S. Cl. CPC H01M 50/595; H01M 50/586

(57) ABSTRACT

A cell includes a stack in which a positive electrode current collector foil, a positive electrode active material layer, a solid electrolyte layer, a negative electrode active material layer, and a negative electrode current collector foil are stacked in a first direction, wherein an insulating tape is attached to a spare length portion of the positive electrode current collector foil or the negative electrode current collector foil, and the insulating tape is disposed to restrict the spare length portion in the first direction.

### CROSS-REFERENCE TO RELATED APPLICATION

Priority is claimed on Japanese Patent Application No. 2025-039004, filed Mar. 12, 2025, the content of which is incorporated herein by reference.

### BACKGROUND OF THE INVENTION

### Field of the Invention

The present invention relates to a cell.

### Description of Related Art

In all-solid-state batteries, since a volume expands due to deposition of lithium during charging, a spare length portion is provided in a current collector foil in advance to prevent it from being torn by the expansion and contraction. However, when a laminate film is deformed during vacuum sealing and the spare length portion is pinched tightly, the spare length portion may not be able to move properly and may become tensed, possibly causing the spare length portion to be torn. Therefore, it is necessary to provide a stable space between the laminate film and an electrode group so that the spare length portion can move sufficiently (refer to, for example, Japanese Unexamined Patent Application, First Publication No. 2023-551521).

### SUMMARY OF THE INVENTION

Although a shape of the laminate film after sealing is stabilized by controlling the material and shape of the laminate film, it is difficult to control a shape of a thin and multi-layer current collector foil with a spare length. Thus, it can be thought that a movable space of a spare length portion is not secured, and the spare length portion may be damaged.

An aspect of the present invention provides a cell capable of curbing damage to a spare length portion.

A cell according to a first aspect of the present invention is characterized in that, the cell including a stack in which a positive electrode current collector foil, a positive electrode active material layer, a solid electrolyte layer, a negative electrode active material layer, and a negative electrode current collector foil are stacked in a first direction, an insulating tape is attached to a spare length portion of the positive electrode current collector foil or the negative electrode current collector foil, and the insulating tape is disposed to restrict the spare length portion in the first direction.

By setting the amount of protrusion of the insulating tape from the positive electrode active material layer or the negative electrode active material layer to an appropriate range, the insulating tape restricts the spare length portion in the first direction. Rigidity of a root portion of the spare length portion is increased, and thus disturbance of the spare length portion movable structure is curbed. Since the spare length portion can move freely, damage to the spare length portion can be curbed. Furthermore, the positive electrode current collector foil and the negative electrode current collector foil can be insulated from each other by the insulating tape.

A cell of a second aspect is based on the cell of the first aspect. An amount of protrusion of the insulating tape from the positive electrode active material layer or the negative electrode active material layer may be 0.1 mm or more and 3.0 mm or less.

When the amount of protrusion of the insulating tape is 0.1 mm or more, the positive electrode current collector foil and the negative electrode current collector foil can be insulated from each other. When the amount of protrusion of the insulating tape is 3.0 mm or less, sharp bending of the spare length portion near a tip end of the insulating tape is curbed.

A cell of a third aspect is based on the cell of the first aspect. An amount of protrusion of the insulating tape from the positive electrode active material layer or the negative electrode active material layer may be 1.0 mm or more and 1.5 mm or less.

Thus, the spare length portion movable structure of the spare length portion is stabilized. Since a large spare length portion accommodating space is formed to allow the spare length portion to move freely, it is possible to curb damage to the spare length portion.

A cell of a fourth aspect is based on the cell of the first aspect and has a tab lead connected to the spare length portion. An amount of protrusion of the insulating tape from the positive electrode active material layer or the negative electrode active material layer may not exceed half a distance from the positive electrode active material layer or the negative electrode active material layer to the tab lead.

Thus, it is possible to curb the spare length being sharply bent near the tip end of the insulating tape.

A cell of a fifth aspect is based on the cell of the first aspect. When a direction in which the spare length portion extends is defined as a second direction, and a direction perpendicular to the first direction and the second direction is defined as a third direction, in the third direction, a width of the insulating tape may be larger than a width of the spare length portion and smaller than a width of the positive electrode active material layer or the negative electrode active material layer.

Since the width of the insulating tape is greater than the width of the spare length portion, the spare length portion can be insulated from the positive electrode current collector foil or the negative electrode current collector foil. Since the width of the insulating tape is smaller than the width of the positive electrode active material layer or the negative electrode active material layer, protrusion of the insulating tape in the third direction is curbed.

A cell of a sixth aspect is based on the cell of the first aspect, the cell has an exterior body formed of a laminate film and the cell is formed by vacuum sealing.

When the cell is vacuum-sealed with the exterior body, the tab lead is pulled toward the stack. However, since the insulating tape acts as a restrictor for the spare length portion, disturbance of the spare length portion movable structure is curbed.

A cell of a seventh aspect is based on the cell of the first aspect. The spare length portion may be pushed in a certain distance toward the positive electrode active material layer or the negative electrode active material layer to form the exterior body, thereby forming a spare length portion movable structure of the spare length portion.

When the spare length portion is pushed in to form the exterior body, the spare length portion movable structure of the spare length portion receives the exterior body. Since a large spare length accommodating space is formed to allow the spare length portion to move freely, it is possible to curb damage to the spare length portion.

According to the aspects of the present invention, it is possible to curb damage to the spare length portion.

### BRIEF DESCRIPTION OF THE DRAWINGS

FIG. 1 is a side cross-sectional view of an electrode group.

FIG. 2 is a side view of a cell to which a tab lead is connected.

FIG. 3 is a CT image of a cross section of a side surface of the cell.

FIG. 4 is a perspective view of the cell.

FIG. 5 is a cross-sectional plan view of the cell.

FIG. 6 is a CT image of a cross section of a side surface of sample A.

FIG. 7 is a CT image of a cross section of a side surface of sample B.

FIG. 8 is a CT image of a cross section of a side surface of sample C.

FIG. 9 is a CT image of a cross section of a side surface of sample D.

### DETAILED DESCRIPTION OF THE INVENTION

An embodiment of the present invention will now be described with reference to the drawings.

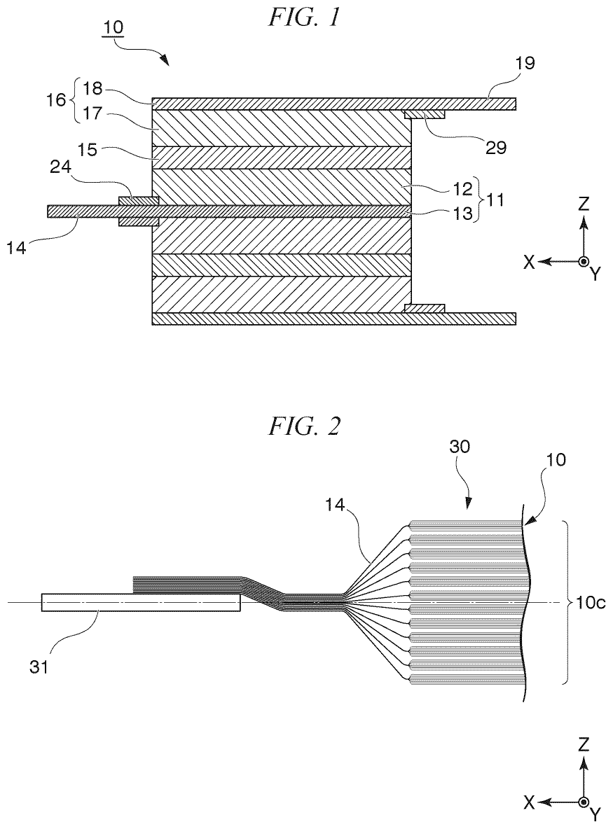

FIG. 1 is a side cross-sectional view of an electrode group 10. The electrode group 10 has a positive electrode 11, a solid electrolyte layer 15, and a negative electrode 16. The positive electrode 11 has a positive electrode active material layer 12 and a positive electrode current collector foil 13, and the negative electrode 16 has a negative electrode active material layer 17 and a negative electrode current collector foil 18. The positive electrode current collector foil 13 has a spare length portion 14, and the negative electrode current collector foil 18 has a spare length portion 19.

In the present application, a Z direction, an X direction, and a Y direction of the Cartesian coordinate system are defined as follows: The Z direction (a first direction) is a stacking direction of a stack of the positive electrode current collector foil 13, the positive electrode active material layer 12, the solid electrolyte layer 15, the negative electrode active material layer 17, and the negative electrode current collector foil 18. The X direction (a second direction) is a direction in which the spare length portion 14 of the positive electrode current collector foil 13 and the spare length portion 19 of the negative electrode current collector foil 18 extend. The Y direction (a third direction) is a direction perpendicular to the Z direction and the X direction.

Examples of active materials that can be used to form the positive electrode active material layer 12 include lithium cobaltate, lithium nickelate, lithium manganate, lithium metal phosphate, lithium nickel cobalt manganate, lithium nickel cobalt aluminate, and the like. The positive electrode active material layer 12 may be a ternary material such as NCM712.

The positive electrode current collector foil 13 is formed of a conductive material such as aluminum (Al).

The solid electrolyte layer 15 is formed of, for example, a solid electrolyte having ionic conductivity. Examples of the material of the solid electrolyte layer 15 include sulfide-based solid electrolyte materials, oxide-based solid electrolyte materials, nitride-based solid electrolyte materials, halide-based solid electrolyte materials, and the like.

Examples of the active material that can be used to form the negative electrode active material layer 17 include lithium-based materials, silicon-based materials, and the like. Examples of the lithium-based materials include Li metal, Li alloys, and the like. Examples of the silicon-based materials include Si, SiO, and the like. Other examples of the active material that can be used to form the negative electrode active material layer 17 include carbon materials such as graphite, soft carbon, and hard carbon, tin-based materials (Sn, SnO, and the like), lithium titanate, and the like.

The negative electrode current collector foil 18 is formed of a conductive material such as copper (Cu).

The spare length portion 14 of the positive electrode current collector foil 13 extends from the positive electrode 11 to one side in the X direction. The spare length portion 19 of the negative electrode current collector foil 18 extends from the negative electrode 16 to the other side in the X direction. The spare length portion 14 of the positive electrode current collector foil 13 and the spare length portion 19 of the negative electrode current collector foil 18 extend in the sides opposite to each other in the X direction. Each of the spare length portions 14 and 19 has a thickness of, for example, about 10 μm.

The electrode group 10 has insulating tapes 24 and 29. The insulating tape 24 is, for example, a cellophane adhesive tape, or the like. The insulating tapes 24 and 29 insulate the positive electrode current collector foil 13 from the negative electrode current collector foil 18. The insulating tape 24 is attached across the spare length portion 14 and the positive electrode current collector foil 13 at a corner between the spare length portion 14 of the positive electrode current collector foil 13 and the positive electrode active material layer 12. The insulating tape 29 is attached across the spare length portion 19 and the negative electrode current collector foil 18 at a corner between the spare length portion 19 of the negative electrode current collector foil 18 and the negative electrode active material layer 17.

In the electrode group 10, a stack of the positive electrode active material layer 12, the solid electrolyte layer 15, the negative electrode active material layer 17, and the negative electrode current collector foil 18 is disposed in this order on both sides of the positive electrode current collector foil 13 in the Z direction.

A cell (a stacked cell) 30 is formed by stacking a plurality of electrode groups (stacked bases) 10 in the Z direction.

FIG. 2 is a side view of the cell 30 to which a tab lead 31 is connected. The following description will be given taking the periphery of the spare length portion 14 of the positive electrode current collector foil 13 as an example, but the same applies to the periphery of the spare length portion 19 of the negative electrode current collector foil 18. Tip ends of the spare length portions 14 of the plurality of electrode groups 10 included in an electrode group stack 10c overlap in the Z direction. The tab lead 31 is connected to the tip ends of the spare length portions 14. The tab lead 31 is formed in a plate shape of a conductive metal material or the like.

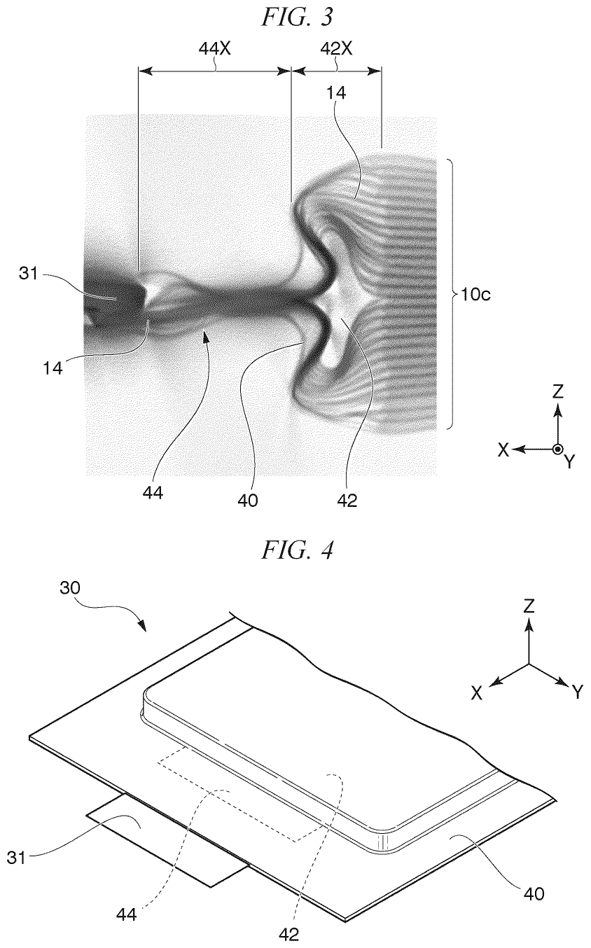

FIG. 3 is a computed tomography (CT) image of a cross section of a side surface of the cell (a module) 30. FIG. 4 is a perspective view of the cell 30. The cell 30 is vacuum-sealed by an exterior body 40 made of a laminate film. The laminate film is formed by, for example, covering front and back surfaces of a metal layer with a resin layer (an insulating layer). As shown in FIG. 4, the tip end of the tab lead 31 is exposed to the outside of the exterior body 40.

As shown in FIG. 3, the exterior body 40 is formed in a state in which the tab lead 31 and the spare length portions 14 are pushed a certain distance toward the electrode group stack 10c. Thus, the spare length portions 14 near the electrode group stack 10c has an onion-shaped spare length portion movable structure. In the spare length portion movable structure, a root portion of the spare length portion 14 bends with a relatively large radius of curvature away from a center of the electrode group stack 10c in the Z direction. Then, the root portion bends with a relatively large radius of curvature toward the side approaching the center of the electrode group stack 10c in the Z direction and toward the side approaching the electrode group stack 10c in the X direction. Then, the root portion bends with a relatively large radius of curvature in the X direction away from the electrode group stack 10c.

The exterior body 40 is formed on the outside of the spare length portion movable structure of the spare length portion 14, and the spare length portion movable structure receives the exterior body 40. Thus, a spare length portion accommodating space 42 is formed between the electrode group stack 10c and the exterior body 40 in the X direction. The spare length portion accommodating space 42 accommodates the spare length portion movable structure of the spare length portion 14. The spare length portion 14 of the spare length portion movable structure can move freely inside the spare length portion accommodating space 42. Therefore, even when a volume of the electrode group stack 10c expands due to deposition of lithium during charging, damage to the spare length portion 14 is curbed.

In the X direction, an intermediate portion 44 of the exterior body 40 is formed between the spare length portion accommodating space 42 and the tab lead 31. The intermediate portion 44 sandwiches the overlapping spare length portion 14 in the Z direction. As shown in FIG. 4, a height of the intermediate portion 44 in the Z direction is smaller than a height of the spare length portion accommodating space 42 in the Z direction.

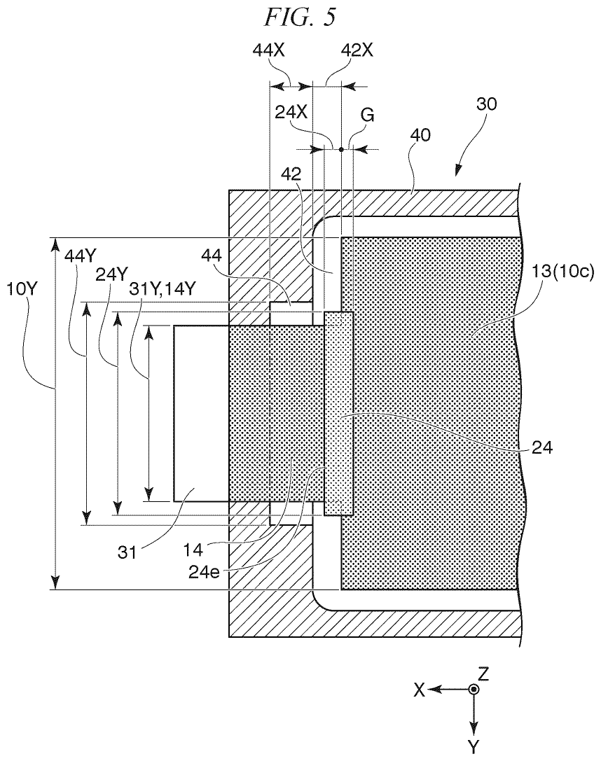

FIG. 5 is a cross-sectional plan view of the cell 30. As described above, the spare length portion accommodating space 42 is formed in the X direction between the electrode group stack 10c and the exterior body 40. A length 42X of the spare length portion accommodating space 42 in the X direction is, for example, 2.0 mm. When the length 42X of the spare length portion accommodating space 42 is short, the spare length portion 14 is sandwiched between the electrode group stack 10c and the exterior body 40, and free movement of the spare length portion 14 is hindered. In the case in which the length 42X of the spare length portion accommodating space 42 is long, when the cell 30 is vacuum-sealed with the exterior body 40, the exterior body 40 that covers the spare length portion accommodating space 42 is likely to be crushed in the Z direction. Thus, the spare length portion 14 is sandwiched between the exterior bodies 40, and thus the free movement of the spare length portion 14 is hindered. When the length 42X of the spare length portion accommodating space 42 is about 2.0 mm, the spare length portion 14 can move freely inside the spare length portion accommodating space 42.

The intermediate portion 44 of the exterior body 40 is formed between the spare length portion accommodating space 42 and the tab lead 31. A length 44X of the intermediate portion 44 in the X direction is, for example, 4.0 mm. A distance in the X direction from the electrode group stack 10c including the positive electrode active material layer 12 and the negative electrode active material layer 17 to the tab lead 31 is, for example, 6.0 mm.

A width 44Y of the intermediate portion 44 in the Y direction is smaller than a width 10Y of the electrode group stack 10c in the Y direction. The width 44Y of the intermediate portion 44 in the Y direction is, for example, 60 mm. The width 44Y of the intermediate portion 44 in the Y direction is greater than a width 14Y of the spare length portion 14 in the Y direction and a width 24Y of the insulating tape 24 in the Y direction. The width 14Y of the spare length portion 14 in the Y direction is, for example, 50 mm. The width 24Y of the insulating tape 24 in the Y direction is, for example, 55 mm.

The width 14Y of the spare length portion 14 in the Y direction is smaller than the width 10Y of the electrode group stack 10c including the positive electrode active material layer 12 and the negative electrode active material layer 17 in the Y direction.

The width 24Y of the insulating tape 24 in the Y direction is greater than the width 14Y of the spare length portion 14 in the Y direction. Thus, the spare length portions 14 and 19 can be insulated from the positive electrode current collector foil 13 or the negative electrode current collector foil 18. The width 24Y of the insulating tape 24 in the Y direction is smaller than the width 10Y of the electrode group stack 10c including the positive electrode active material layers 12 and the negative electrode active material layers 17 in the Y direction. Thus, it is possible to curb the insulating tape 24 protruding in the Y direction.

The insulating tape 24 is attached across the spare length portion 14 and the positive electrode current collector foil 13. A length G of a portion at which the insulating tape 24 and the positive electrode current collector foil 13 overlap in the X direction (an adhesive margin of the insulating tape 24 on the positive electrode current collector foil 13) is, for example, 0.5 mm. The insulating tape 24 that protrudes from the electrode group stack 10c in the X direction is attached to the spare length portion 14.

By attaching the insulating tape 24 to the spare length portion 14, the insulating tape 24 restricts the spare length portion 14 in the Z direction. This increases rigidity of the root portion of the spare length portion 14, and thus disturbance of the spare length portion movable structure of the spare length portion 14 is curbed. Since the spare length portion can move freely, damage to the spare length portion can be curbed.

When the cells 30 are vacuum-sealed with the exterior body 40, the tab lead 31 is pulled toward the electrode group stack 10c. However, since the insulating tape 24 acts as a regulator for the spare length portion 14, disturbance of the spare length portion movable structure of the spare length portion 14 is curbed.

Four types of samples were created with different lengths 24X of the insulating tape 24 that protrudes from the electrode group stack 10c in the X direction (hereinafter, referred to as an amount of protrusion of the insulating tape 24), and a state of the spare length portion movable structure of the spare length portion 14 was confirmed. The four types of samples are shown in Table 1.

TABLE 1

| Sample | A | B | C | D |
|---|---|---|---|---|
| Amount of | 0 (No | 1.5 | 2.0 | 4.0 |
| protrusion of | insulating | | | |
| insulating tape | tape) | | | |
| (mm) | | | | |
| Amount of pull-in | 0.150 | 0.115 | 0.130 | 1.106 |
| of tab lead | | | | |
| (mm) | | | | |

Sample A is a case in which the insulating tape 24 is not used, and an amount 24X of protrusion of the insulating tape 24 is 0 mm. In the amount 24X of protrusion of the insulating tape 24 in each of samples B to D, sample B is 1.5 mm, sample C is 2.0 mm, and sample D is 4.0 mm.

An amount of pull-in of the tab lead 31 was measured as shown in Table 1. The tab lead 31 was connected to the spare length portion 19 of the negative electrode current collector foil 18. The amounts of pull-in of both samples B and C were small, and were good results. In contrast, the amount of pull-in of sample D was large, and disturbance of the spare length portion movable structure was confirmed, as will be described below.

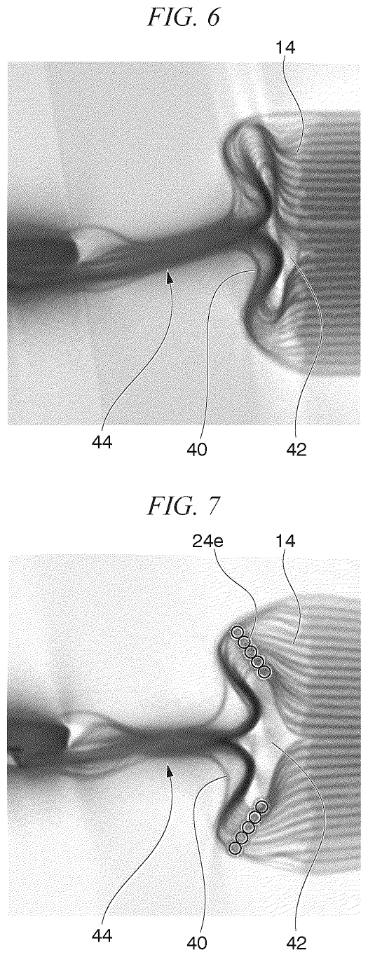

FIGS. 6 to 9 are CT images of cross sections of side surfaces of samples A to D. The state of the spare length portion movable structure of the spare length portion 14 of the positive electrode current collector foil 13 was confirmed from the CT image of the cross section of the side surface of each sample. An evaluation item for the spare length portion movable structure include the presence of the spare length portion accommodating space 42 in which the spare length portion 14 can freely move, and the absence of deformation of the electrode group stack 10c.

FIG. 6 is a CT image of the cross section of the side surface of sample A. Since sample A does not have the insulating tape 24, the spare length portion 14 is deformed from the root portion thereof. As a result, the spare length portion accommodating space 42 is smaller. Furthermore, the upper and lower spare length portions 14 in the Z direction do not deform symmetrically, and shapes thereof are not stable.

FIG. 7 is a CT image of the cross section of the side surface of sample B. In FIGS. 7 to 9, a circle is marked on a tip end 24e of the insulating tape 24. The amount 24X of protrusion of the insulating tape 24 of sample B is 1.5 mm. The root portion of the spare length portion 14 stands up, and a large spare length portion accommodating space 42 is formed. Thus, there is the spare length portion accommodating space 42 in which the spare length portion 14 can move freely. Furthermore, the upper and lower spare length portions 14 in the Z direction deform symmetrically, and a stable spare length portion movable structure is formed.

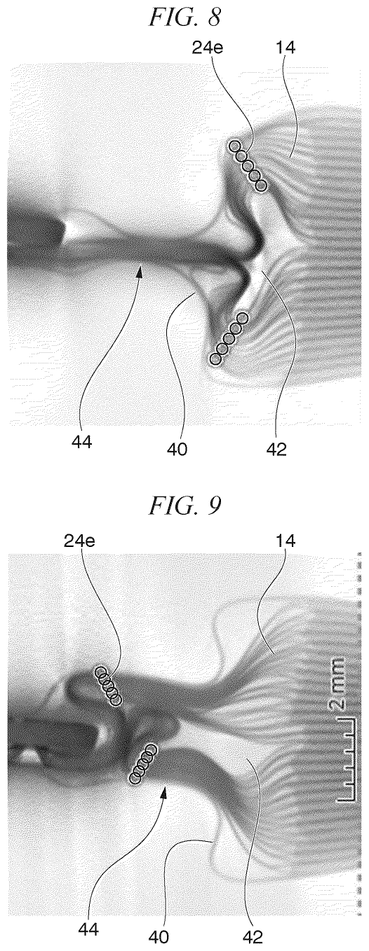

FIG. 8 is a CT image of the cross section of the side surface of sample C. The amount 24X of protrusion of the insulating tape 24 of sample C is 2.0 mm. As described above with reference to FIG. 5, the length 42X of the spare length portion accommodating space 42 in the X direction is 2.0 mm. Therefore, in the X direction, the tip end 24e of the insulating tape 24 reaches a position of the intermediate portion 44 of the exterior body 40. As shown in FIG. 8, as the intermediate portion 44 is formed, the spare length portion 14 near the tip end 24e of the insulating tape 24 is bent sharply. Thus, it is believed that the free movement of a part of the spare length portion 14 is hindered.

FIG. 9 is a CT image of the cross section of the side surface of sample D. The amount 24X of protrusion of the insulating tape 24 of sample D is 4.0 mm. The root portion of the spare length portion 14 extends almost without bending in the spare length portion accommodating space 42. In the X direction, the tip end 24e of the insulating tape 24 extends to the vicinity of the center of the intermediate portion 44. In the intermediate portion 44, the spare length portion 14 near the tip end 24e of the insulating tape 24 is bent sharply. It is believed that a large load is applied to the spare length portion 14, and the free movement of the spare length portion 14 is hindered. Furthermore, since the tip end of the spare length portion 14 is inserted into the intermediate portion 44, the intermediate portion 44 is molded in a state in which it expands in the Z direction. Thus, it is believed that the rigidity of the exterior body 40 was reduced, and as shown in Table 1, the amount of pull-in of the tab lead 31 increased.

From the above results, it is desirable to set the amount 24X of protrusion of the insulating tape 24 to about 1.5 mm. Thus, when the cell 30 is vacuum-sealed with the exterior body 40, the spare length portion movable structure of the spare length portion 14 is stabilized. The spare length portion 14 can move freely inside the spare length portion accommodating space 42. Therefore, even when the volume of the electrode group stack 10c expands due to deposition of lithium during charging, damage to the spare length portion 14 is curbed.

As described above in detail, the cell 30 of the embodiment is characterized in that, in a stack in which the positive electrode current collector foil 13, the positive electrode active material layer 12, the solid electrolyte layer 15, the negative electrode active material layer 17, and the negative electrode current collector foil 18 are stacked in the first direction, the insulating tapes 24 and 29 are attached to the spare length portions 14 and 19 of the positive electrode current collector foil 13 or the negative electrode current collector foil 18, and the insulating tapes 24 and 29 are disposed to restrict the spare length portions 14 and 19 in the Z direction.

By setting the amount of protrusion of the insulating tapes 24 and 29 from the positive electrode active material layer 12 or the negative electrode active material layer 17 within an appropriate range, the insulating tapes 24 and 29 restrict the spare length portions 14 and 19 in the Z direction. The rigidity of the root portions of the spare length portions 14 and 19 is increased, and thus disturbance of the spare length portion movable structure of the spare length portions 14 and 19 is curbed. Since the spare length portions 14 and 19 can move freely, damage to the spare length portions 14 and 19 can be curbed. Furthermore, the insulating tapes 24 and 29 can insulate the positive electrode current collector foil 13 from the negative electrode current collector foil 18.

The amount of protrusion of the insulating tapes 24 and 29 from the positive electrode active material layer 12 or the negative electrode active material layer 17 is preferably 0.1 mm or more and 3.0 mm or less.

When the amount of protrusion of the insulating tapes 24 and 29 is 0.1 mm or more, the positive electrode current collector foil 13 and the negative electrode active material layer 17 can be insulated from each other. When the amount of protrusion of the insulating tapes 24 and 29 is 3.0 mm or less, sharp bending of the spare length portions 14 and 19 near the tip ends of the insulating tapes 24 and 29 is curbed.

The amount of protrusion of the insulating tapes 24 and 29 from the positive electrode active material layer 12 or the negative electrode active material layer 17 is preferably 1.0 mm or more and 1.5 mm or less.

Thus, the spare length portion movable structure of the spare length portions 14 and 19 is stabilized. Since the large spare length portion accommodating space 42 is formed to allow the spare length portions 14 and 19 to move freely, it is possible to curb damage to the spare length portions 14 and 19.

The tab lead 31 connected to the spare length portions 14 and 19 is further provided. It is desirable that the amount of protrusion of the insulating tapes 24 and 29 from the positive electrode active material layer 12 or the negative electrode active material layer 17 does not exceed half the distance from the positive electrode active material layer 12 or the negative electrode active material layer 17 to the tab lead 31. The amount of protrusion of the insulating tapes 24 and 29 is, for example, less than 3.0 mm.

Thus, it is possible to curb the spare length portions 14 and 19 near the tip ends of the insulating tapes 24 and 29 being sharply bent.

The configurations in the above-described embodiments are merely examples of the present invention, and various modifications are possible without departing from the gist of the present invention, such as replacing the components of the embodiments with well-known components.

What is claimed is:

1. A cell comprising:
a stack in which a positive electrode current collector foil, a positive electrode active material layer, a solid electrolyte layer, a negative electrode active material layer, and a negative electrode current collector foil are stacked in a first direction,
wherein an insulating tape is attached to a spare length portion of the positive electrode current collector foil or the negative electrode current collector foil, and
the insulating tape is disposed to restrict movement of the spare length portion in the first direction.

2. The cell according to claim 1, wherein an amount of protrusion of the insulating tape from the positive electrode active material layer or the negative electrode active material layer is 0.1 mm or more and 3.0 mm or less.

3. The cell according to claim 1, wherein an amount of protrusion of the insulating tape from the positive electrode active material layer or the negative electrode active material layer is 1.0 mm or more and 1.5 mm or less.

4. The cell according to claim 1, further comprising a tab lead connected to the spare length portion,
wherein an amount of protrusion of the insulating tape from the positive electrode active material layer or the negative electrode active material layer does not exceed half a distance from the positive electrode active material layer or the negative electrode active material layer to the tab lead.

5. The cell according to claim 1, wherein, when a direction in which the spare length portion extends is defined as a second direction, and a direction perpendicular to the first direction and the second direction is defined as a third direction,
in the third direction, a width of the insulating tape is larger than a width of the spare length portion and smaller than a width of the positive electrode active material layer or the negative electrode active material layer.

6. The cell according to claim 1, wherein the cell has an exterior body formed of a laminate film, and the cell is formed by vacuum sealing.

7. The cell according to claim 6, wherein the spare length portion is pushed in a predetermined distance toward the positive electrode active material layer or the negative electrode active material layer to form the exterior body, thereby forming a spare length portion movable structure of the spare length portion.
